(19) United States
(12) Patent Application Publication
(10) Pub. No.: US 2015/0148117 A1
(43) Pub. Date: May 28, 2015

(54) SLOT TYPE GAME AND GAMING MACHINE

(71) Applicant: Salvatore Falciglia, SR., Ridgewood, NJ (US)

(72) Inventor: Salvatore Falciglia, SR., Ridgewood, NJ (US)

(21) Appl. No.: 14/541,133

(22) Filed: Nov. 13, 2014

Related U.S. Application Data
(60) Provisional application No. 61/909,450, filed on Nov. 27, 2013.

(51) Int. Cl. G07F 17/32; G07F 17/34

(52) U.S. Cl. CPC G07F 17/3288; G07F 17/34
USPC 463/20

(57) ABSTRACT

In a slot-type game, a plurality of base reels display a set of base symbols or indicia. One or more additional or extra reels display replacement symbols. Under certain circumstances, a replacement symbol displayed by the extra reel may be used in substitution to one of the base symbols in order to form a winning set of symbols.

### RELATED APPLICATION DATA

This application claims priority to U.S. Provisional Application Ser. No. 61/909,450, filed Nov. 27, 2013.

### FIELD OF THE INVENTION

The present invention relates to methods of playing and presenting games and gaming machines.

### BACKGROUND OF THE INVENTION

A variety of wagering style games and gaming machines for presenting those games are known. However, players continue to seek new and exciting games.

### SUMMARY OF THE INVENTION

Embodiments of the invention comprise methods of presenting games, methods of playing games and gaming machines for presenting games. In a preferred embodiment, games of the invention are wagering type games.

In one embodiment of a game of the invention, a plurality of base reels display a base set of symbols or indicia. One or more extra reels display one or more symbols which, at certain times or based upon certain criteria, can be used in substitution of symbols in the base set in order to generate game wins.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine in accordance with an embodiment of the invention;

FIG. 2 illustrates a game layout in accordance with one embodiment of the invention;

FIGS. 3A and 3B illustrate a first example of game play in accordance with the invention; and

FIG. 4 illustrates a second example of game play in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In a preferred embodiment, the methods of game play and presentation are implemented via a gaming machine or device 22. Such a gaming machine 22 may have various configurations.

The gaming machine 22 may be located at a casino (and as such may be referred to as a “casino gaming machine”). As described below, the gaming machine 22 may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

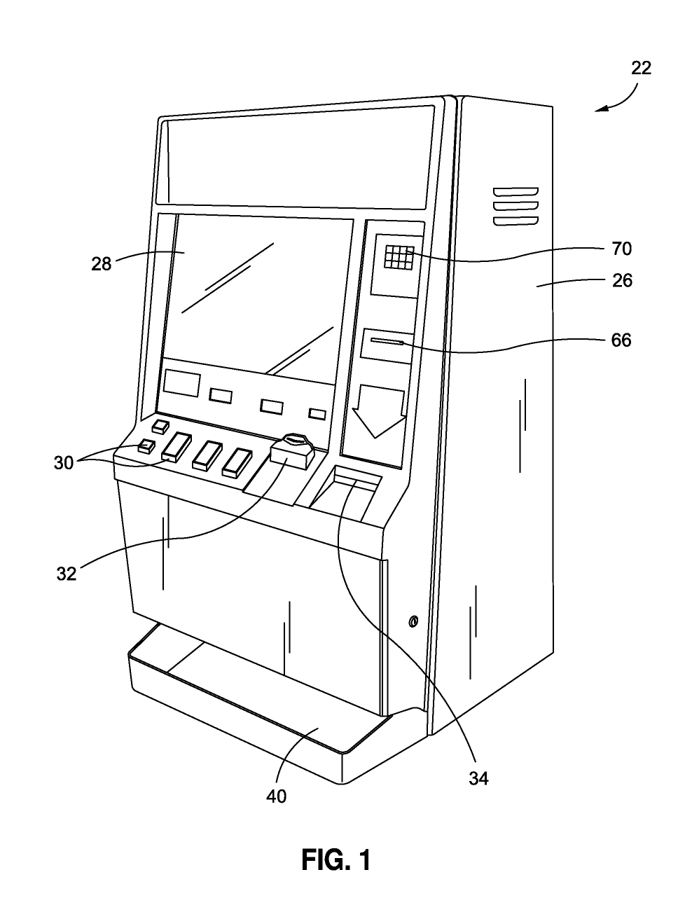

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed reels and associated game symbols), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting slot symbols and for presenting the game in a random fashion (i.e. whereby the outcome of the game is not controlled by or known to the player).

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause slot symbols (as described below) to be displayed on the at least one display 28. The controller may accept input from a player of symbols to move or replace (as described below) via the one or more player input devices of the gaming machine 22 (in the event the symbol movement/replacement is not performed automatically by the machine).

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray 40. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays. The games of the invention could also be presented by or at hand-held devices, such as PDAs, cellular phones, tablet computing devices or the like.

A casino may have numerous such gaming machines 22, such as located on a casino floor or in other locations. Of course, such gaming machines 22 might be used in other environments, such as an airport, a bar or tavern or other locations.

In another embodiment, the gaming machine 22 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

Game Version 1

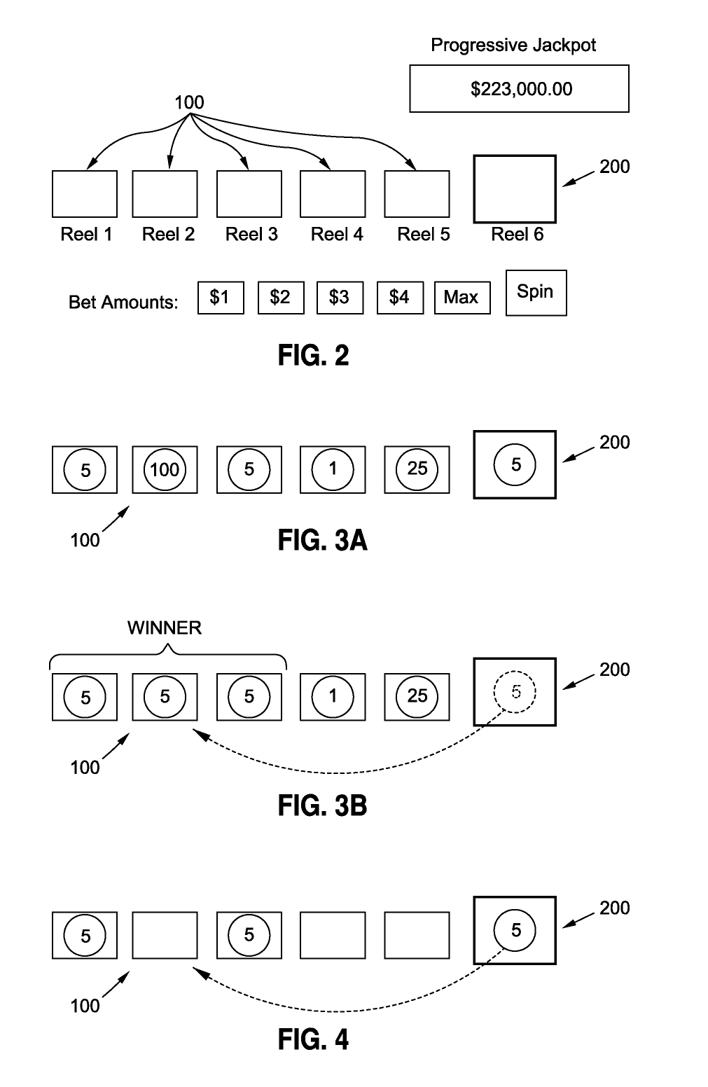

A first version of a method of playing and presenting a game will be described with reference to FIG. 2.

The gaming machine has or displays a number of base reels 100 and one or more additional or extra reels 200. In one embodiment, the gaming machine has or displays 5 base reels plus a single additional or 6th reel. The 6^{th} reel may be larger. As indicated above, the reels may be physical reels (such as rotating cylinders which bear symbols) or virtual reels (e.g. a graphical representation of reels or associated symbols displayed by one or more electronic video displays), or combinations or hybrids thereof.

The icons or symbols associated with the base reels and additional reels consist of a mixture of symbols or indicia, such as symbols comprising: One Unit chips; Five Unit chips; Twenty-Five Unit chips; One hundred Unit chips; and Five hundred Unit chips. The chips may comprise graphical representations of chips used in casinos and may be marked with or have associated values.

The mixture or distribution of symbols associated with their reel, and their number, may vary. For example, each reel might have 50 symbols associated therewith (physically or virtually), wherein 10 of each of the 5 different chip symbols may be associated with the reel in different positions. Alternatively, there may be different numbers of each symbol associated with each reel, such as to create a certain probability distribution of winning to non-winning outcomes and a certain probability distribution of specific winning outcomes (for example, reel 1 might have 19 “One Unit chips” and only 1 “Five hundred Unit chip” instead of 10 each of those chips, whereby the probability of obtaining a “One Unit chip” win is higher than that for the “Five hundred Unit chip”). Preferably, each base reel 100 and the additional reel 200 includes at least one of each of the different types of symbols so that combinations of the same symbol can be obtained along or across all of the reels, for reasons described below. In addition, in a preferred embodiment of the invention, the one or more additional reels 200, such as the 6^{th} reel, preferably has associated therewith the base reel symbols plus at least one Wild or Joker chip

The object of the game is to receive certain predetermined combinations of displayed symbols. In a preferred embodiment, the object of the game is to get as many of the same symbol in a row as possible across the base reels 100 (e.g. the same denomination chips next to each other on the 5 reels). In a preferred embodiment, a plurality of outcomes are possible and some, but not all of those outcomes are designed as winning. For example, winning outcomes might comprise at least 3 of the same symbol in a row. One example, of a pay table of winning outcomes is illustrated in Table I below.

In general, the reels are utilized to display random combinations of symbols. Each reel may display more than one symbol (for example, each physical reel or graphically represented reel may have a plurality of symbols associated therewith and the reel may be configured to display three symbols upon each spin). In one embodiment, combinations of symbols are evaluated, however, along one or more lines or pay lines. For example, combinations of symbols may be evaluated along a single horizontal pay line. The reels may display symbols above and below the payline so that a player can see “how close” they were to receiving other symbols.

In one embodiment, after a player places a wager the game starts with all of the reels spinning (e.g. the base reels 100 and all additional reels 200, such as all 6 reels in the preferred embodiment). The spinning may comprise a physical rotation of physical reels or different graphical representations of reels in a video environment.

In one embodiment, the base reels 100 are stopped first and then the one or more additional reels 200. For example, the base reels 100 may be stopped and then, after the 5^{th} reel stops, the 6^{th} reel is stopped (such as 3 seconds later). The time gap between the stopping of the base reels 100 and the additional reel(s) 200 allows a player to see the outcome of the base reels and to build anticipation for potential outcomes of the additional reel(s) which would yield a winning outcome.

Most importantly, in accordance with the present invention, the player can use the symbol which is displayed on the additional reel(s) (such as the 6^{th} reel) in replacement or substitution of any symbol on one of the base reels (such as the base 5 reels), to try and form one or more winning outcomes. For example, the player may utilize the symbol displayed on the additional reel 200 in replacement for a symbol on one of the base reels 100 to form a combination of multiple of the same symbol across the base reels.

If the base reels 100 display a winning combination of symbols without replacement of a symbol from the additional reel(s), the player may be awarded an award, such as based upon the pay table. If the base reels 100 display a winning combination of symbols with replacement of a symbol from the additional reel(s) 200, the player may be awarded an award, such as based upon the pay table. In one embodiment, a player might be paid winnings for winning combinations of symbols without replacement of a symbol based upon a first pay table and winnings for winning combinations for symbols with replacement of one or more symbols based upon a second pay table (such as where the payouts for the first pay table are higher than those for the second pay table).

In one embodiment, when a symbol from an additional reel 200 (such as the 6^{th} reel) is used in substitution of one of the base symbols displayed by the base reels 100, that additional symbol may be displayed in place of the original base symbol. In other embodiments, the additional symbol might not actually be re-displayed on the base reel. It will also be appreciated that if the game includes two or more additional reels 200, then the player may have the opportunity to replace more than one base symbol with an additional or replacement symbol, thus providing a higher probability of achieving a winning outcome.

In one embodiment, the player might be offered the opportunity to spin the additional reel(s) 200 one or more additional times in order to achieve a winning outcome or a higher paying winning outcome. For example, the player might be offered “Do you want to buy an extra spin on the 6^{th} reel for X unit? YES or NO.” This offer might be provided at the end of the game, such as if the player did not receive an initial winning outcome.

If so, then the additional reel(s) are respun and the player may again utilize the symbol(s) displayed on the additional reel(s) 200 replacement of a symbol on the base reels 100 to form a winning outcome or a higher winning outcome. With this feature a player would preferably only be paid if a winning outcome were received when one was not received originally or if a higher winning outcome were received (so that a player is not paid twice for the same outcome).

One example of play of a game of the invention is described below with reference to FIGS. 3A and 3B. FIG. 3A illustrates the outcome of a spin of 5 base reels 100 and a single additional reel 200. The base reels 100 display a set of base symbols and the additional reel 200 displays an additional symbol. In this case, replacement of the 100 Unit chip displayed by Reel 2 with the 5 Unit chip displayed by Reel 6 would result in a game win (a combination of three consecutive 5 Unit chips). As such, an indicator might be provided to the player (such as the 6^{th} reel blinking or via other visual or aural indicators). Either automatically or based upon player input, the 100 Unit chip is replaced by the 5 Unit chip (such as by the player touching the 100 Unit chip), such as illustrated in FIG. 3B.

It will be appreciated that if the additional (6^{th} reel in this case) displayed a Joker or other “wild” symbol, that symbol might have been used in replacement of the 100 Unit chip on Reel 2 to form a winning outcome.

The one or more additional reels may have certain features or attributes. For example, as indicated above, the additional reel might blink or provide other visual indicators if the symbol it displays will make a win for the player.

As indicated, the additional reel may include a Joker or other “wild” symbol which may be considered to have the characteristics of one or more or all of the other symbols. The Joker or wild symbol may have two functions.

First, the Joker or other wild symbol can replace any symbol on the base reels with any symbol which will give the player the highest payout (see above example wherein the 5 unit chip on the 6^{th} reel could replace the 100 unit chip on the 2^{nd} reel in order to make a sequence of three 5 units chips, for a winning combination).

Second, if the player receives matching symbols on all of the base reels and a Joker on the 6^{th} reel (or all additional reels), the player may win a jackpot or high award, such as a Progressive Jackpot (e.g. a jackpot which grows over time, such as based upon the number of games played or amounts wagered by players).

When the spin of the base reels 100 (before any payouts) show the 1^{st}, 3^{rd} and 5^{th} reel with the same icon, the player gets one Free Spin on the at least one additional reel 200, such as the 6^{th} reel. The base reels 100 are processed for wins after the Free Spin is taken.

When the spin of the base reels 100 (before any payouts) show the 2^{nd} and 4^{th} reel with the same icon, the player gets one Free Spin on the at least one additional reel 200, such as the 6^{th} reel. The base reels 100 are processed for wins after the Free Spin is taken.

In one embodiment, a player may be required to place at least a minimum wager (such as via one or more wager input buttons or the like) in order to play the game. In one embodiment, the player must make a maximum bet to be eligible to win the Progressive Jackpot.

Set forth below is but one example of a pay table of the invention which displays example winning game outcomes and associated award values. It will be appreciated that the winning outcomes and/or award values might vary depending upon the desires of the game designer (such as to achieve a certain payout/payback ratio or house hold on the game).

TABLE I
Payouts:

| Unit Chip | Payout |
|---|---|
| 3 of the 1 unit denomination chips touching each other = | X units × bet amount |
| 4 of the 1 unit denomination chips touching each other = | X units × bet amount |
| 5 of the 1 unit denomination chips touching each other = | X units × bet amount |
| 3 of the 5 unit denomination chips touching each other = | X units × bet amount |
| 4 of the 5 unit denomination chips touching each other = | X units × bet amount |
| 5 of the 5 unit denomination chips touching each other = | X units × bet amount |
| 3 of the 25 unit denomination chips touching each other = | X units × bet amount |
| 4 of the 25 unit denomination chips touching each other = | X units × bet amount |
| 5 of the 25 unit denomination chips touching each other = | X units × bet amount |
| 3 of the 100 unit denomination chips touching each other = | X units × bet amount |
| 4 of the 100 unit denomination chips touching each other = | X units × bet amount |
| 5 of the 100 unit denomination chips touching each other = | X units × bet amount |
| 3 of the 500 unit denomination chips touching each other = | X units × bet amount |
| 4 of the 500 unit denomination chips touching each other = | X units × bet amount |
| 5 of the 500 unit denomination chips touching each other = | X units × bet amount |

Game Version 2

A second version of a method of playing and presenting a game will be described with reference to FIG. 4. This version of the game is similar to that described above, including the variants thereof. In this configuration of the game, all reels 100,200 are spun. The reels 100 are then stopped in sequence, such as: Reel 1 stops, Reel 2 stops, Reel 3 stops, Reel 4 stops, Reel 5 stops, and Reel 6 continues to spin.

When the last base reel 100 (such as Reel 5) stops and if there is no way to make a possible win regardless of the outcome of the additional reel(s) 200 (e.g. the 6^{th} reel in this case), then the game ends.

If, however, when the base reels 100 stop spinning and there is a win or a possible win, then the base symbols displayed by those base reels 100 which display a win or which could form a win continue to be displayed, while the symbols on the other base reels 100 are removed (such as by turning blank automatically). The 6^{th} reel now stops. If the 6^{th} reel displays a symbol which forms a win (a specific symbol or a Joker/wild symbol) with the symbols which continue to be displayed by the base reels, then that symbol is moved (automatically or by input by the player, such as the player placing the symbol in one of the blank reel positions) to make a win.

If the at least one additional reel 200 (such as the 6^{th} reel) does not display an additional symbol which can be used to form a winning combination, then nothing happens.

As with the first version of the game, after this sequence of game play, the player may be offered one or more additional opportunity to spin the additional reel(s), such as by asking “Do you want to buy an extra spin on the 6^{th} reel for X unit? YES or NO.” At this point all wins are processed.

One example of this embodiment of the game is described below with reference to FIG. 4. In this example, the base reels 100 displayed symbols, but only Reel 1 and Reel 3 displayed symbols which could be used to form a winning combination. As such, the remaining base reels 100 went blank. The additional reel 200 (the 6^{th} reel) then stopped and displayed a 5 Unit chip which could be used to form a game win. As such, the 6^{th} reel might blink, etc., and the symbol on the 6^{th} reel is preferably moved (automatically or based upon player input) to the Reel 2 to form a winning combination of three 5 Unit chips.

This version of the game may have the other features and elements as described above relative to the first version, such as a Progressive Jackpot, Joker (or other wild symbols), etc.

Of course, other embodiments of the invention are contemplated. While certain game symbols have been described as being used to present the game above, other game symbols could be utilized. The game symbols could be numbers, letters, pictures, other indicia or combinations thereof. For example, the game symbols could comprise pictures of cherries, stars, etc., each of which has a designated value.

In the embodiment illustrated each reel is configured to display a single symbol for use in evaluating the game outcome. In other embodiments, the reels might be configured to display two or more symbols, such as in two rows (or additional reels might be utilized). In such a configuration, the game outcome might be determined relative to a first row of symbols, a second row of symbols, etc., or even other combinations of symbols such as vertical columns, diagonals or other patterns. Preferably, however, the other principles of the invention (symbol substitution from an extra reel) is utilized.

In the example provided 5 base reels are utilized along with a single 6^{th} reel. However, in other embodiments there might be a fewer or greater number of base reels and/or more than one 6^{th} reel.

In addition, the payouts and winning combinations of symbols could vary. For example, payouts could be based upon the amount wagered or be fixed. Further, the payouts for particular wins could vary, such as to result in a desired house hold and payout percentage for the game.

As used herein, the term Unit may comprise a “credit”, such as a numeric value which has a representative monetary value. For example, a unit or credit might have a representative value of $0.01, $0.25, $1.00 or other amount.

The principles of the invention are not intended to be limited to slot games. For example, the principles of the invention could be applied to other types of games including, as indicated above, games which use other types of indicia or symbols (such as playing card symbols or the like). For example, aspects of the game include playing or presenting a game having two components, namely a base game portion and a secondary or additional portion. The secondary or additional portion of the game, e.g. additional symbols used in placement of base game symbols, might be applied to other types of base games.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a controller;
at least one electronic video display;
at least one player input device;
at least one wager accepting device;
machine-readable code executable by said controller to cause said at least one electronic video display to randomly display a base set of symbols associated with a base set of reels;
machine-readable code executable by said controller to cause said at least one electronic display to randomly display at least one additional symbol associated with at least one additional reel;
machine-readable code executable by said controller to determine whether said based set of symbols or said base set of symbols as modified by substituting one of the symbols thereof with said at least one additional symbol, comprises a predetermined winning combination of symbols; and
machine-readable code executable by said controller to cause said controller to award an award for predetermine winning combinations of symbols.

2. The gaming machine in accordance with claim 1 wherein said base set of reels comprises at least 3 reels.

3. The gaming machine in accordance with claim 1 wherein said base set of reels comprises 5 reels.

4. The gaming machine in accordance with claim 1 wherein said at least one additional reel comprises a single reel.

5. The gaming machine in accordance with claim 1 wherein each of said base set of reels and each additional reel has at least one of each of a plurality of different symbols associated therewith.

6. The gaming machine in accordance with claim 5 wherein each additional reel includes at least one wild symbol.

7. The gaming machine in accordance with claim 1 wherein said at least one predetermined winning combination of symbols comprises the same symbol displayed by three consecutive reels.

8. The gaming machine in accordance with claim 1 wherein said controller is configured to cause said at least one electronic video display to display said at least one additional symbol in substitution of one of said base set of symbols.

9. The gaming machine in accordance with claim 1 wherein said award comprises a progressive jackpot if said symbols of said base set of symbols are all identical and said at least one additional symbol comprises a predetermined symbol.

10. The gaming machine in accordance with claim 9 wherein said predetermined symbol comprises a wild symbol.

11. The gaming machine in accordance with claim 1 further comprising at least one random number generator executed by said controller, said at least one random number generator utilized by said controller to determine said base set of symbols and said at least one additional symbol.

12. The gaming machine in accordance with claim 1 further comprising machine-readable code configured to cause said controller to cause said at least one additional reel to display at least one second additional symbol and to determine whether said based set of symbols as modified by substituting one of the symbols thereof with said at least one second additional symbol comprises a predetermined winning combination of symbols.

13. The gaming machine in accordance with claim 12 wherein said controller causes said at least one additional reel to display at least one second additional symbol in response to an additional wager placed by said player.

14. The gaming machine in accordance with claim 12 wherein said controller causes said at least one additional reel to display at least one second additional symbol in response to a predetermined non-winning combination of base symbols.
